(19) United States
(12) Patent Application Publication
(10) Pub. No.: US 2020/0341302 A1
(43) Pub. Date: Oct. 29, 2020

(54) Transparent Bag

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 16/544,933

(22) Filed: Aug. 20, 2019

(30) Foreign Application Priority Data
Apr. 26, 2019 (CN) 201910345429.7

(51) Int. Cl. G02F 1/137; G02F 1/1334; G02F 1/133; A45C 3/00; A45C 15/00

(52) U.S. Cl. CPC G02F 1/137; G02F 1/1334; A45C 2200/10; A45C 3/001; A45C 15/00; G02F 1/13306

(57) ABSTRACT

The present application provides a transparent bag, the transparent bag comprises a bag body, and further comprises a front transparent body, a rear body and a control circuit, wherein, both of the front transparent body and the rear transparent body include a protecting film and an intelligent film, the control circuit is used for controlling the intelligent film to be in a transparent state or in a non-transparent state, the intelligent film is used for converting the transparent state or the non-transparent state according to a signal of the control circuit. The technology solution provided by the present application has the advantage of improving the experience of a user.

### CROSS-REFERENCE TO RELATED APPLICATION

The present application is based upon and claims priority to Chinese patent application No. 201910345429.7, filed on Apr. 26, 2019, the entire content of which is incorporated herein by reference.

### TECHNICAL FIELD

The disclosure relates to the field of garments, and particularly relates to a transparent bag.

### BACKGROUND

A school bag refers to a bag made of cloth, leather and the like. A student uses the school bag to carry books and stationeries. Depending on change in tastes of a customer, the school bag is developed into a school bag capable of more relieving student's burdens, namely, a box-type bag. The material of the box-type bag is more diversified. The box-type bag made of genuine leather, PU, terylene, canvas, cotton and linen and the like leads to a fashion trend. Meanwhile, in the era of more and more personalization, simple, old-fashioned, cartoon and other styles also cater to the needs of fashion people to publicize their personality from different aspects.

The present school bag is non-transparent, and such the school bag cannot embody personalization, thereby influencing the experience of a user.

### SUMMARY

An embodiment of the present application provides a transparent bag to achieve the transparency of a school bag, thereby improving the experience of a user.

The first embodiment of the present application provides a transparent bag, wherein the transparent bag includes a bag body, and further includes a front transparent body, a rear body and a control circuit, wherein, both of the front transparent body and the rear transparent body include a protecting film and an intelligent film, the control circuit is used for controlling the intelligent film to be in a transparent state or in a non-transparent state, the intelligent film is used for converting the transparent state or the non-transparent state according to a signal of the control circuit;

the left lower corner and the right lower corner of the front transparent body are provided with flexible protection portions, and the right lower corner and the left lower corner of the rear transparent body are provided with flexible protection portions.

Preferably, the intelligent film includes a front conducting film, a rear conducting film and a middle component; the inner side surface of the front conducting film is adhered and fixed to the front surface of the middle component, and the inner side surface of the rear conducting film is adhered and fixed to the rear surface of the middle component; the protecting film is adhered and fixed to the outer side surface of the front conducting film or the outer side surface of the rear conducting film; the middle component is a component having molecules ordering arrangement in an electric field and having molecules disordering arrangement without the electric field.

Preferably, the middle component specifically is a mixed material of a liquid crystal body and a high polymer material filling material.

Preferably, the control circuit includes a power source and a switch, wherein, one end of the switch is connected with the front conducting film, and the other end of the switch is connected with a positive electrode of the power source, and a negative electrode of the power source is connected with the rear conducting film.

Preferably, the flexible protection portion is of a hollow structure, the round corner of the flexible protection portion is flexible plastic, the linear location of the flexible protection portion is hard plastic, the hollow structure is internally provided with dichloromethane liquid the volume of which is smaller than that of the hollow structure.

The implementation of the embodiment of the present application has the following beneficial effects:

it can be seen that the present application provides a transparent bag, the transparent bag includes an intelligent film which can be a transparent film after being electrified, and a non-transparent film in a non-electrified state. In such a way, whether the bag is transparent or not is determined depending on user's preference, and thus the transparent bag has the advantage of improving the experience of a user.

### BRIEF DESCRIPTION OF THE DRAWINGS

For more clearly describing the technical solution in the embodiment of the present application, drawings required to be used in description of the embodiment will be simply introduced, apparently, the drawings described below are some embodiments of the present application, for those of ordinary skill in the art can also obtain other drawings according to these drawings without creative efforts.

FIG. 1 is a structural diagram of a transparent bag according to an embodiment of the present application.

FIG. 2 is a structural diagram of an intelligent film according to the embodiment of the present application.

FIG. 2a is an electrified light diagram of an intelligent film according to the embodiment of the present application.

FIG. 2b is a non-electrified light diagram of an intelligent film according to the embodiment of the present application.

FIG. 3 is a structural diagram of a flexible protection portion according to the embodiment of the present application.

### DESCRIPTION OF THE EMBODIMENTS

The technical solution in an embodiment of the present application will be clearly and completely described in combination with drawings in the embodiment of the present application below, apparently, the described embodiments are parts of embodiments of the present application, but not all the embodiments. Based on the embodiment of the present application, other embodiments obtained by those of ordinary skill in the art without creative efforts are all included within the protection scope of the present application.

Terms “first”, “second”, “third” and “fourth” or the like used in the specification and claims as well as the drawings of the present application are intended to distinguish different objects, but not describe a specific sequence. Furthermore, terms “including” and “having” as well as any transformations thereof are intended to cover non-exclusive comprising. For example, processes, methods, systems, products or devices comprising a series of steps or units are not limited to steps or units that have been listed, and optionally include steps or units that have not been listed, or optionally also include other steps or units that are inherent to these processes, methods, products or devices.

“Embodiment” mentioned herein means that specific features, structures or properties described in combination with the embodiment can be contained in at least one embodiment of the present application. Embodiments where this phrase occurs at various locations of the specification do not necessarily refer to the same embodiments, and are not independent or alternative embodiments mutually exclusive one another. It is explicitly and implicitly understood for those skilled in the art that embodiments described herein can be combined with other embodiments.

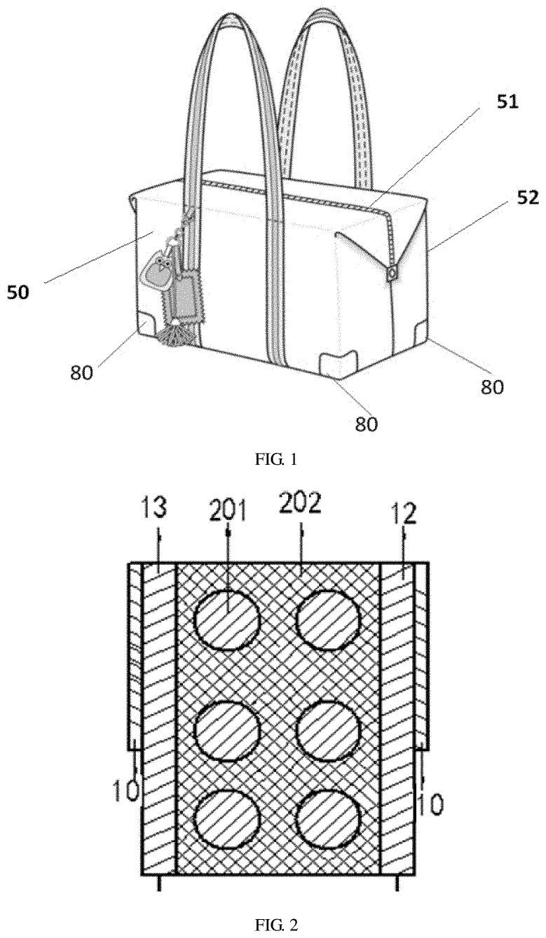

Referring to FIG. 1, FIG. 1 is a transparent bag. As shown in FIG. 1, the transparent bag includes a front transparent body 50, a rear transparent body 51, a bag body 52 and a control circuit, wherein, both of the front transparent body 50 and the rear transparent body 51 include a protecting film 10 and an intelligent film 20, the control circuit is used for controlling the intelligent film 20 to be in a transparent state or in a non-transparent state, the intelligent film 20 is used for converting the transparent state or the non-transparent state according to a signal of the control circuit.

The present application provides a transparent bag, the transparent bag includes the front transparent body 50 and the rear transparent body 51, wherein, both of the front transparent body 50 and the rear transparent body 51 include the intelligent film 20, the intelligent film 20 may be a transparent film after being electrified and a non-transparent film in a non-electrified state, in such a way, whether this bag is transparent or not is determined depending on user's preference. Thus, the present application has the advantage of improving the experience of a user.

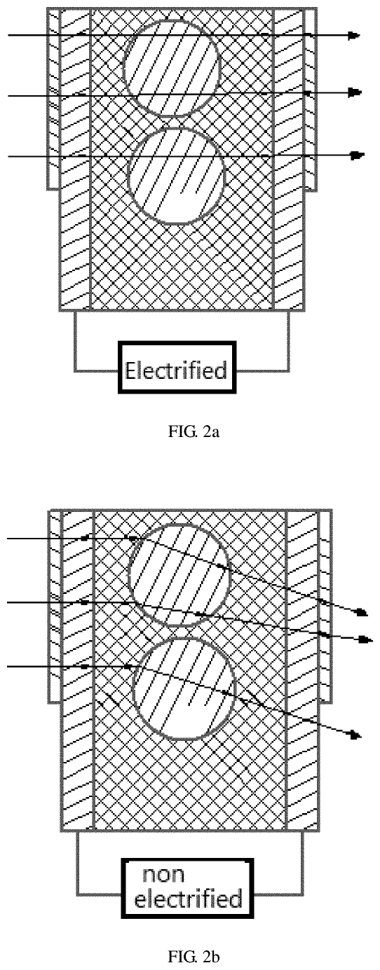

Preferably, the above intelligent film 20, as shown in FIG. 2, includes a front conducting film 12, a rear conducting film 13 and a middle component 20; the inner side surface of the front conducting film 12 is adhered and fixed to the front surface of the middle component, and the inner side surface of the rear conducting film 13 is adhered and fixed to the rear surface of the middle component; the protecting film 10 is adhered and fixed to the outer side surface of the front conducting film 12 or the outer side surface of the rear conducting film 13; the middle component is a component having molecules ordering arrangement in an electric field and having molecules disordering arrangement without the electric field, for example liquid crystal material.

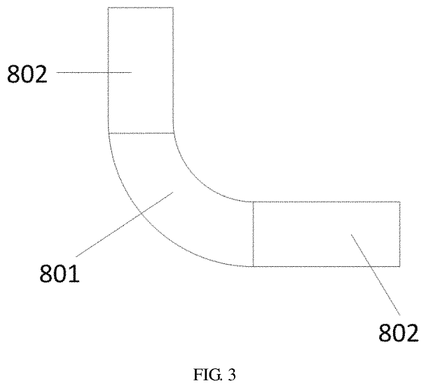

Preferably, as shown in FIG. 1, the left lower corner and the right lower corner of the front transparent body 50 are provided with flexible protection portions 80, and the right lower corner and the left lower corner of the rear transparent body 51 are provided with flexible protection portions 80. As shown in FIG. 3, the flexible protection portion 80 is of a hollow structure, the round corner 801 of the flexible protection portion 80 is flexible plastic (transparent), the linear location 802 of the flexible protection portion 80 is hard plastic (transparent), the hollow structure is internally provided with dichloromethane liquid the volume of which is smaller than that of the hollow structure.

For the transparent bag, since the middle component carried by the transparent bag is a liquid crystal body, the requirement of the transparent bag on its shock resistance is improved, and especially, four corners are extremely easily broken. In order to better protect four corners from being damaged, the flexible protection portion is specifically disposed here, and the round corner of the flexible protection portion 80 is set to be flexible plastic, and the hollow structure is filled with a part of dichloromethane liquid, in such a way, when the transparent bag falls down, the round corners touch the ground. Since the round corners are firstly landed, at this moment, most dichloromethane liquid is concentrated on the round corners where accumulation of large forces is generated after falling down so that the dichloromethane liquid is splattered to the linear location 802, the splattered dichloromethane liquid takes away parts of falling kinetic energy, in such a way, the four corners can be fewer damaged, and thus the flexible protection portion has an effect of protecting the liquid crystal body from being damaged.

The above middle component may specifically be composed of a mixed material of a liquid crystal body 201 and a high polymer material filling material 202. The above liquid crystal body may be a liquid crystal display screen material, the above high polymer material may be a light-transmitting high polymer material, the above liquid crystal body may specifically be a liquid crystal material having molecules ordering arrangement in an electric field and having molecules disordering arrangement without the electric field, for example an orientation layer of a liquid crystal display screen.

Referring to FIG. 2a, FIG. 2a is a light-transmitting diagram of a structure of FIG. 1 of the present application. As shown in FIG. 2b, FIG. 2b is a non-light-transmitting diagram of a structure of a FIG. 1 of the present application. As shown in FIG. 2a, if the control circuit 14 is electrified, the molecules of the liquid crystal body are in ordering arrangement, at this moment, lights directly penetrate through the whole middle component, and the structure has good light-transmitting performance; if the control circuit 14 is not electrified, molecules of the liquid crystal body are in disordering arrangement, at this moment, lights can be reflected when penetrating through the liquid crystal body, as shown in FIG. 2b, the lights can be scattered, so as to achieve a lightproof purpose.

The above control circuit may include a power source and a switch, wherein, the switch is a film switch, one end of the switch is connected with the front conducting film 12, and the other end of the switch is connected with a positive electrode of the power source, and a negative electrode of the power source is connected with the rear conducting film 13. The above control circuit may be disposed at any positions of the bag body, particular position may be voluntarily set by a designer of the transparent bag, and therefore, the particular position of this control circuit is not drawn in figures of the present application.

It is noted that for the sake of a brief description, the foregoing various method embodiments are described as a series of action combinations, but those skilled in the art should be aware that the present application is not limited by the described action sequence, as some steps may be performed in other sequences or simultaneously according to the present application. Secondly, those skilled in the art should also be aware that the embodiments described in the specification are all optional embodiments and the actions and modules involved are not necessarily required for the present application.

In the above embodiments, the description of each embodiment has its own emphasis, and parts that are not detailed in one embodiment may refer to the relevant descriptions of other embodiments.

In several embodiments provided by the present application, it is understood that the disclosed device can be achieved in other manners. For example, the above described device embodiments are only exemplary, for example, division of the units is only division of logical functions, other division manners may be present when in practical achievement, for example, multiple units or components may be combined or integrated to another system, or some features may be ignored, or not implemented. From another aspect, the displayed or discussed mutual coupling or direct coupling or communication connection may be indirect coupling or communication connection through some interfaces, devices or units, and may be in electrical or other forms.

The units described as separated components may be or may also not be physically separated. The components displayed as display units may be or may also be not physical units, namely, may be located at one place, or may also be distributed to multiple network units. Parts or all of the units here may be selected according to a practical need to achieve the purposes of the solutions of the embodiments of the present application.

In addition, various functional units in various embodiments of the present application can be integrated in one processing unit, or various units can be individually physically present, or two or more units can be integrated in one unit. The above integrated units can be achieved in a hardware form, or in a software program module.

When the integrated unit is achieved in a form of the software program module and sold or used as an independent product, it can be memorized in one computer readable memory. Based on this understanding, technical solutions of the present application substantively, or a part thereof making a contribution to the prior art, or all of or parts of this technical solution, may be reflected in the form of a software product stored in a memorizer, including several instructions to enable a computer equipment (e.g., personal computer, server, network facility, etc.) to execute all of or parts of the steps in the methods of respective embodiments of the present application. The memory mentioned above includes: a U disk, a read-only memory (ROM), a random access memory (RAM), a mobile hard disk, a disk or CD, and other media that can store program code.

It can be understood by those skilled in the art that all or parts of the steps in the various methods of the above embodiments can be accomplished by directing the relevant hardware through a program that can be stored in a computer readable memory, which may include: a flash disk, a read-only memory (ROM) and a random access memory (RAM), a disk or CD, etc.

The embodiments of the present application are described in detail above. The principle and implementation of the present application are described with specific examples herein. The description of the above embodiments is only used for helping to understand the method and core ideas of the present application. At the same time, for those of ordinary skill in the art, specific implementations and application scopes can all be varied according to the thought of the present application. In summary, the contents of this specification should not be construed as limiting the present application.

What is claimed is:

1. A transparent bag comprising a bag body, wherein the transparent bag further comprises a front transparent body, a rear body and a control circuit, both of the front transparent body and the rear transparent body comprise a protecting film and an intelligent film, the control circuit is used for controlling the intelligent film to be in a transparent state or in a non-transparent state, the intelligent film is used for converting the transparent state or the non-transparent state according to a signal of the control circuit;
the left lower corner and the right lower corner of the front transparent body are provided with flexible protection portions, and the right lower corner and the left lower corner of the rear transparent body are provided with flexible protection portions.

2. The transparent bag of claim 1, wherein the intelligent film comprises a front conducting film, a rear conducting film and a middle component; the inner side surface of the front conducting film is adhered and fixed to the front surface of the middle component, and the inner side surface of the rear conducting film is adhered and fixed to the rear surface of the middle component; the protecting film is adhered and fixed to the outer side surface of the front conducting film or the outer side surface of the rear conducting film; the middle component is a component having molecules ordering arrangement in an electric field and having molecules disordering arrangement without the electric field.

3. The transparent bag of claim 2, wherein the middle component is a mixed material of a liquid crystal body and a high polymer material filling material.

4. The transparent bag of claim 2, wherein the control circuit comprises a power source and a switch, one end of the switch is connected with the front conducting film, and the other end of the switch is connected with a positive electrode of the power source, and a negative electrode of the power source is connected with the rear conducting film.

5. The transparent bag of claim 1, wherein the flexible protection portion is of a hollow structure, the round corner of the flexible protection portion is flexible plastic, the linear location of the flexible protection portion is hard plastic, the hollow structure is internally provided with dichloromethane liquid the volume of which is smaller than that of the hollow structure.
